(19) United States
(12) Patent Application Publication
(10) Pub. No.: US 2006/0255103 A1
(43) Pub. Date: Nov. 16, 2006

(54) Joining method for heterogeneous metal parts of a golf club head

(75) Inventors: Shyi-Kaan Wu, Taipei City (TW); Ren-Kae Shiue, Hualien Hsien (TW); Yuan-Ping Lu, Bade City (TW)

Correspondence Address: BIRCH STEWART KOLASCH & BIRCH, PO BOX 747, FALLS CHURCH, VA, 22040-0747, US

(73) Assignee: Fu Sheng Industrial Co., Ltd.

(21) Appl. No.: 11/184,783

(22) Filed: Jul. 20, 2005

(30) Foreign Application Priority Data
May 16, 2005 (TW) 94115780

(51) Int. Cl. B23K 31/02; B23K 1/20; B23K 35/24

(52) U.S. Cl. 228/225; 228/214; 228/208

(57) ABSTRACT

A joining method for connecting heterogeneous metal parts includes the steps of: prefabricating a first connecting surface on a first metal part, and a second connecting surface on a second metal part; disposing at least one barrier layer on one of the first and second connecting surfaces of the first and second metal parts by a plating process; disposing a filler metal between the first and second connecting surfaces of the first and second metal parts such that the filler metal being sandwiched in-between the first and second metal parts; heating the filler metal disposed between the first and second connecting surfaces of the first and second metal parts; and cooling and solidifying of the molten filler metal connected between the first and second connecting surfaces of the first and second metal parts to constitute a golf club head.

### BACKGROUND OF THE INVENTION

1. Field of the Invention

The present invention relates to a joining method for connecting heterogeneous metal parts of a golf club head. Particularly, the present invention relates to a joining method for using a barrier layer on at least one of heterogeneous metal parts of a golf club head. More particularly, the present invention relates to a joining method for using a barrier layer on at least one of heterogeneous metal parts of a golf club head for infrared brazing that improves metallurgical compatibility of heterogeneous joint for different metals and brazing strength of joined heterogeneous metal parts.

2. Description of the Related Art

In golf club head industry, the current trend is towards a plurality of heterogeneous metal parts to constitute a club head body. In general, the golf club head is widely designed for manufacturing by composite metals. For example, a club head body and a striking plate are separately made of heterogeneous metals and then assembled to constitute the golf club head. A number of design limitations, however, exist for these heterogeneous metal parts due to poor welding compatibility. As a result, a welding method is incapable of directly applying to join the heterogeneous metal parts. With regard to the problem occurring during the welding operation, there are some other methods, including mechanically snap fitting, adhesion or brazing, provided for choice in joining the heterogeneous metal parts of the golf club head.

In preparing the brazing operation, a filler metal must be disposed on a connecting surface of the heterogeneous metal part before the heterogeneous metal parts of the golf club head are joined. Subsequently, the heterogeneous metal parts of the golf club head are heated to melt the filler metal in a furnace for a predetermined time such that the melting filler metal can wet the connecting surfaces of the heterogeneous metal parts. A complete joint between the connecting surfaces of the heterogeneous metal parts is carried out once the filler metal is cooled down and solidified. A high temperature can cause a metallurgical reaction between the filler metal and the heterogeneous metal parts excessively even though the brazing operation is relatively convenient in use. The excessive metallurgical reaction between the filler metal and the heterogeneous metal parts causes some of the filler metal dissolved into the heterogeneous metal parts. Conversely, the excessive metallurgical reaction between the filler metal and the heterogeneous metal parts also causes some elements of the heterogeneous metal parts melting into the filler metal by a dissolution effect. When this occurs, this results in changes in ingredient of the heterogeneous metal parts adjacent to the joint therebetween. This may affect fluidity, the wettability of the filler metal, and the strength of the joint of the heterogeneous metal parts, so-called alloying effect. Additionally, there is a brittle intermetallic layer existing in an interface of the filler metal and the heterogeneous metal parts. The mechanical strength or durability of the joint of the heterogeneous metal parts has deteriorated in the event if the brittle intermetallic layer is in excess of a specific thickness.

Given the brazing operation between stainless steel and titanium alloy, there is a brittle titanium intermetallic layer formed on a connecting surface of the stainless steel side that can affect strength of the joint of the parts. In consideration of such a technical problem or limitation, the mechanical snap fitting or adhesion becomes a major joining method for joining the heterogeneous metal parts in the known art.

US Patent Application Publication No. US 2005/0091820, entitled “using infrared ray for quick joining a golf club head,” discloses an infrared joining process for joining heterogeneous metal parts of a golf club head. In the infrared joining process, infrared generated from a quartz lamp (tube) is a heat source used to rapidly heat the heterogeneous metal parts of the golf club head. In preparing the infrared joining process, filler metal with a low melting point is disposed between two connecting surfaces of the parts with a relatively high melting point. After melting the filler metal, the melting filler metal wets two connecting surfaces of the parts by capillary attraction so that two connecting surfaces of the parts are securely connected. Infrared can penetrate the quartz lamp (tube) placed in a furnace and reflect from the quartz lamp (tube) to the heterogeneous metal parts arranged in a heating zone. In the furnace only the heating zone is used to heat up the heterogeneous metal parts of the golf club head and other unheated zones are not. Concretely, the infrared joining method has a high speed of heating (i.e. high heating efficiency) and cooling (i.e. high heat-dissipating efficiency) characteristics. Advantageously, this results in a reduction of a processing time to the infrared joining.

Furthermore, several optical lenses are used to focus infrared so as to increase energy density and heating rate of infrared in the infrared joining. Hence, the infrared heating is undoubtedly an economic and practical utility for a joining method.

The infrared joining method cannot effectively or completely eliminate the existence of the brittle interfacial intermetallic layer, even though it can advantageously suppress growing of the brittle intermetallic layer in the process. In the infrared joining process, a brazed joint between the heterogeneous metal parts is constructed via metallurgical reactions of filler metal melting and filler metal solidification. The brazed joint between the heterogeneous metal parts involves in a series of rapid metallurgical reactions (e.g. filler metal melting and filler metal solidification). Lowering the operational temperature and processing time in the infrared joining process can suppress the growth of brittle intermetallic layer(s). Unfortunately, such practice may, however, suppress melting of the filler metal or reaction of the metal parts. This results in an ineffective joint with insufficient strength to withstand normal usage. Consequently, quality of the brazed joint between the heterogeneous metal parts is deteriorated.

Currently, there has been an increased need for solving such a problem resulted from the conventional brazing process in the golf club head industry. Hence, there is a desire for the joint between the heterogeneous metal parts to have a preferred impact resistance of the striking performance. To this end, in the brazing process, it should avoid alloying or growth of the brittle intermetallic layer(s) as far as possible so as to increase reliability of the brazed joint.

The present invention intends to provide a joining method for connecting heterogeneous metal parts (i.e. stainless steel and titanium alloy) of a golf club head, wherein a barrier layer is formed on at least one connecting surface of at least one of the heterogeneous metal parts. Thereby, the barrier layer can separate the molten filler metals from reacting with the connecting surface of the heterogeneous metal part in such a way to mitigate and overcome the above problem.

### SUMMARY OF THE INVENTION

The primary objective of this invention is to provide a joining method for connecting heterogeneous metal parts of a golf club head, wherein a barrier layer is disposed on a connecting surface of at least one of the heterogeneous metal parts. Thereby, the connecting surface of the heterogeneous metal part covered with the barrier layer cannot react with filler metals in high-temperature operation.

The secondary objective of this invention is to provide the joining method for connecting the heterogeneous metal parts of the golf club head, wherein a barrier layer is plated on a connecting surface of at least one of the heterogeneous metal parts prior to a brazing process. Thereby, the barrier layer can prevent the connecting surface of the heterogeneous metal part from occurring metallurgical reactions with the filler metal in the brazing process.

The joining method for connecting heterogeneous metal parts the golf club head in accordance with the present invention includes the steps of: prefabricating a first connecting surface on a first metal part, and a second connecting surface on a second metal part; disposing at least one barrier layer on one of the first and second connecting surfaces of the first and second metal parts by a plating process; disposing a filler metal between the first and second connecting surfaces of the first and second metal parts such that the filler metal being sandwiched in-between the first and second metal parts; heating the filler metal disposed between the first and second connecting surfaces of the first and second metal parts; and cooling and solidifying the molten filler metal connected between the first and second connecting surfaces of the first and second metal parts to constitute the golf club head.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an exploded perspective view of heterogeneous metal parts of a golf club head for use in processing a joining method in accordance with a preferred embodiment of the present invention;

FIG. 2 is an exploded cross-sectional view of heterogeneous metal parts of another golf club head for use in processing the joining method in accordance with the preferred embodiment of the present invention; FIG. 3A is a photomicrograph of a cross section between connecting surfaces of Ti-6Al-4V alloy/72Ag-28Cu alloy/17-4PH stainless steel, without forming a barrier layer, taken after thermal treatment at 850° C. for 120 sec; wherein the upper portion showing Ti-6Al-4V alloy, and the lower portion occurring a shear section in a shear test.

FIG. 3B is a photomicrograph, similar to FIG. 3A, of a cross section between connecting surfaces of Ti-6Al-4V alloy/72Ag-28Cu alloy/17-4PH stainless steel, without forming a barrier layer, taken after thermal treatment at 850° C. for 300 sec;

FIG. 3C is a photomicrograph, similar to FIG. 3A, of a cross section between connecting surfaces of Ti-6Al-4V alloy/72Ag-28Cu alloy/17-4PH stainless steel, without forming a barrier layer, taken after thermal treatment at 900° C. for 120 sec; and

FIG. 3D is a photomicrograph, similar to FIG. 3A, of a cross section between connecting surfaces of Ti-6Al-4V alloy/72Ag-28Cu alloy/17-4PH stainless steel, without forming a barrier layer, taken after thermal treatment at 900° C. for 300 sec.

### DETAILED DESCRIPTION OF THE INVENTION

A joining method for connecting heterogeneous metal parts of a golf club head in accordance with the present invention is applied to brazing, particularly furnace-type brazing and infrared-type high-energy brazing for example. In the illustrated embodiment, an infrared-heating apparatus is applied in an infrared brazing process. The infrared-heating apparatus consists of a quartz lamp (tube) and a reflecting curved condenser, and operates at a maximum temperature ranging between 500° C. and 1500° C. and rated power ranging between 5.0 kW and 25.0 kW. In the infrared brazing process, the infrared-heating apparatus can use a kind of inert gases (i.e. argon) to protect the heterogeneous metal parts from oxidation during infrared brazing.

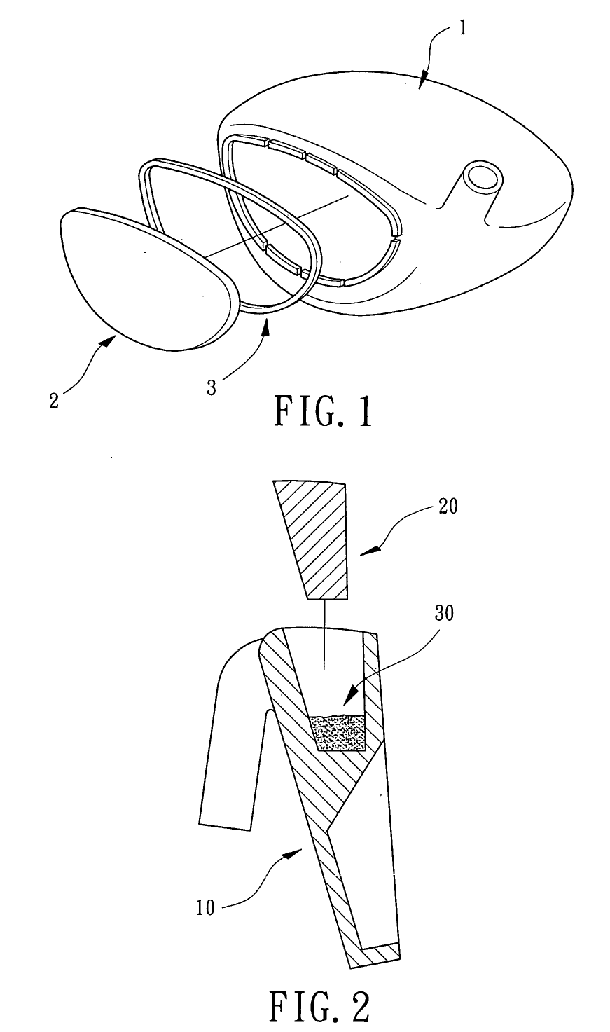

FIG. 1 illustrates heterogeneous metal parts of a golf club head for use in processing a joining met-hod in accordance with a preferred embodiment of the present invention. The wood-type golf club head essentially includes at least two or several metal parts. Referring to FIG. 1, the wood-type golf club head generally includes a golf club head body designated numeral 1; a striking plate designated numeral 2; and a filler metal designate numeral 3.

Still referring to FIG. 1, the joining method in accordance with the preferred embodiment of the present invention includes a first step for prefabricating a first connecting surface on the golf club head body 1, and a second connecting surface on the striking plate 2. It will be understood that the golf club head body 1 can be regarded as a first metal part, and the striking plate 2 as a second metal part. The first connecting surface of the golf club head body 1 is corresponding to the second connecting surface of the striking plate 2.

Subsequently, the joining method in accordance with the preferred embodiment of the present invention includes a second step for disposing a barrier layer (not shown) on one of the first and second connecting surfaces of the golf club head body 1 and the striking plate 2. A plating process or some other suitable forming means can be employed in an alternative embodiment, the barrier layers are formed on both of the golf club head body 1 and the striking plate 2. Preferably, the barrier layer has a thickness ranging between 1-100 μm. In the illustrated embodiment, each of the barrier layers is integrally formed on the first and second connecting surfaces of the golf club head body 1 and the striking plate 2. Once formed, the first and second connecting surfaces of the golf club head body 1 and the striking plate 2 are faced with the barrier layers.

Subsequently, the joining method in accordance with the preferred embodiment of the present invention includes a third step for disposing the filler metal 3 between the first and second connecting surfaces of the golf club head body 1 and the striking plate 2. In the illustrated embodiment, the filler metal 3 is a ring member and sandwiched in-between the golf club head body 1 and the striking plate 2. Preferably, the first and second connecting surfaces of the golf club head body 1 and the striking plate 2 are in perfect alignment with each other via the filler metal 3.

Subsequently, the joining method in accordance with the preferred embodiment of the present invention includes a fourth step for heating the filler metal 3 disposed between the first and second connecting surfaces of the golf club head body 1 and the striking plate 2. The infrared-heating apparatus or a high-energy neater is used to heat the filler metal 3 at a predetermined temperature so that the filler metals 3 are melted to wet the connecting surfaces of the golf club head body 1 and the striking plate 2. When this occurs, the barrier layers separate at least the connecting surfaces of the golf club head body 1 and the striking plate 2 from the melting filler metal 3. This results in suppression of growing a brittle interfacial layer(s) on one of the golf club head body 1 and the striking plate 2.

Finally, the joining method in accordance with the preferred embodiment of the present invention includes a fifth step for cooling and solidifying the molten filler metal 3 connected between the first and second connecting surfaces of the golf club head body 1 and the striking plate 2. Once cooled and solidified, the solidified filler metal 3 securely connects the golf club head body 1 with the striking plate 2 so as to constitute the wood-type golf club head.

Still referring to FIG. 1, the golf club head body 1 is preferably constructed from 17-4PH stainless steel or some other suitable stainless steel. The striking plate 2 is preferably constructed from Ti-6Al-4V alloy or some other titanium alloy. The golf club head body 1 and the striking plate 2 have ordinary or common forms in manufacture. As to the filler metal 3, in this instance, it preferably constructed from 72Ag-28Cu filler, more preferably from metals selected from silver-based, nickel-based, copper-based or titanium-based alloy.

Turning now to FIG. 2, it illustrates heterogeneous metal parts of another golf club head for use in the processing the joining method in accordance with the preferred embodiment of the present invention. In the illustrated embodiment, the iron-type golf club head generally includes a golf club head body designated numeral 10; a weight member designated numeral 20; and a filler metal designate numeral 30.

Still referring to FIG. 2, the golf club head body 10 is preferably constructed from ferrous-based or nickel-based alloy. The weight member 20 is preferably constructed from any metal or alloy (e.g. tungsten, tungsten alloy, copper alloy, lead alloy) having a specific gravity greater than that of the golf club head body 10. The golf club head body 10 and the weight member 20 have ordinary or common forms in manufacture. As to the filler metal 30, in this instance, it is preferably constructed from metals selected from silver-based, nickel-based, copper-based or titanium-based alloy and suitable for brazing.

The joining method in accordance with the preferred embodiment of the present invention includes a step for disposing barrier layers (not shown) on the first and second connecting surfaces of the golf club head body 10 and the weight 20 by a plating process in order to prevent occurring a brittle intermetallic layer. Preferably, the barrier layer has a thickness ranging between 1-100 μm. Next, the filler metal 30 is disposed in a recession of the golf club head body 10 in which to receive the weight member 20. Next, the filler metal 30 is heated to melt at a predetermined temperature by infrared energy. Once cooled and solidified, the solidified filler metal 30 securely connects the golf club head body 10 with the weight member 20 so as to constitute the iron-type golf club head.

It should be appreciated that the combination of Ti-6Al-4V alloy/72Ag-28Cu alloy/17-4PH stainless steel is exemplified in the present invention. Shear Strength for a joint piece forming no barrier layer (i.e. an experiment group) and a joint piece forming a barrier layer (i.e. a control group) are given below.

Table 1 shows experimental data of the combination of Ti-6Al-4V alloy/72Ag-28Cu alloy/17-4PH stainless steel forming no barrier layer (i.e. an experiment group) obtained in a shear test. It can be observed that as operational temperature or time or both increases, an example slice of Ti-6Al-4V alloy/72Ag-28Cu alloy/17-4PH stainless steel do not increase its joint strength, but it decreases its joint strength. The decrease of joint strength results from a brittle interfacial reaction metal layer produced or grown in the brazed joint. In high-temperature operation, atoms of one metal can easily diffuse and react with other metals that result in growing a thicker brittle intermetallic layer on a boundary between two substrates. However, a structural weakness exists in the brittle intermetallic layer formed between two metal layers. This results in a shear section along the interfacial intermetallic layer formed between two substrates.

TABLE 1
Experimental Data of Ti—6Al—4V Alloy/72Ag—28Cu Alloy/17-
4PH Stainless Steel Forming No Barrier Layer

| Temp. × Time | Shearing stress (MPa) | Avg. shearing stress (MPa) |
|---|---|---|
| 800° C. × 300 sec | 29.4 | 25.9 |
| | 22.4 | |
| 850° C. × 120 sec | 65.5 | 68.2 |
| | 70.9 | |
| 850° C. × 300 sec | 56.2 | 53.2 |
| | 50.1 | |
| 900° C. × 30 sec | 44.2 | 46.5 |
| | 48.8 | |
| 900° C. × 120 sec | 39.3 | 36.9 |
| | 34.4 | |
| 900° C. × 300 sec | 22.8 | 21.8 |
| | 20.7 | |

In order to obtain an exact position of a shear section of the example slice, the shear test example slice is embedded appropriately and sliced along a cross section. After the shear test, the example slice of Ti-6Al-4V alloy/72Ag-28Cu alloy/17-4PH stainless steel is ground and polished in a metallographic treatment. A shear section existed in the example slice can be observed by scanning electron microscope (SEM).

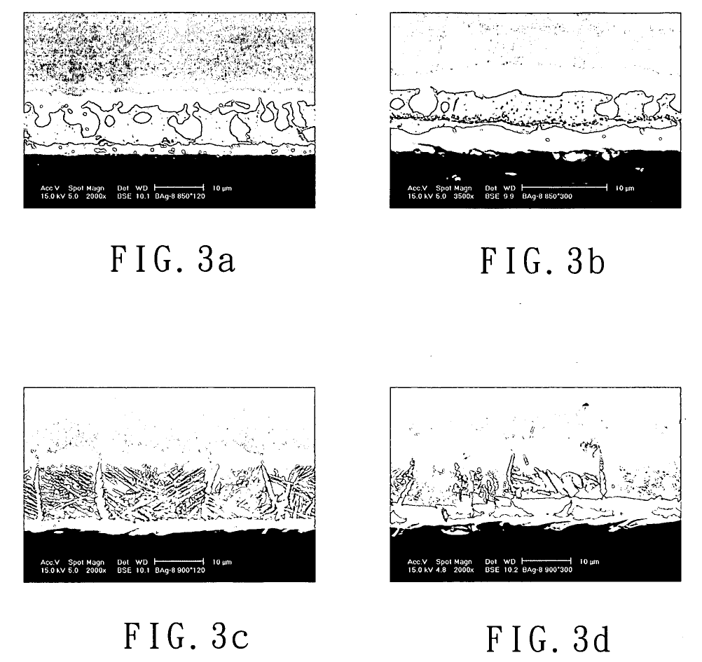

FIGS. 3a through 3d illustrate photomicrographs of a cross section between connecting surfaces of Ti-6Al-4V alloy/72Ag-28Cu alloy/17-4PH stainless steel, without forming a barrier layer. In FIGS. 3a through 3d, the upper portion shows Ti-6Al-4V alloy, and the lower portion occurs a shear section in a shear test. It can be observed that a shear section occurs along a interfacial reaction layer formed between the filler metal and 17-4PH stainless steel. It can be found that, in the same high temperature, as the operational time increases, a brittle interfacial intermetallic layer has an increase of the thickness at the same time. This observation demonstrates the same phenomenon and does not contradict the previous inference of decreasing shear strength of the example specimen.

In the shear test, it is evident that a shear surface of the example slice possesses several shear features. In observation and chemical composition analysis with an energy dispersive spectrometer (EDS), it is shown that the chemical composition of the shear surface mainly includes titanium (Ti), iron (Fe) and copper (Cu). The ratio of titanium atoms to copper and iron atoms is 43% to 45%-50%. It is inferred that the shear surface mainly consists of Ti—Cu and Ti—Fe compounds. Under high temperature and long processing time in brazing, there exists a cleavage characteristic in the shear surface. It appears that a thicker brittle intermetallic layer is produced in the joint such that the cleavage characteristic occurs in the brittle interfacial reaction layer.

As has been discussed, in the experiment group, when Ti-6Al-4V alloy and 17-4PH stainless steel are joined, there is a major problem in titanium atoms of Ti-6Al-4V alloy. In high-temperature heating process, titanium atoms are dissolved into the silver-based molten filler, and diffused from the melted silver-based filler into the connecting surface of 17-4PH stainless steel. Consequently, the titanium atoms react with 17-4PH stainless steel to form a Ti—Fe intermetallic compound (or Ti—Cu intermallic compound) on the connecting surface. The reaction layer is a weakest layer of the joint since the intermetallic layer is usually brittle and successively accumulated on the connecting surface. Such a reaction layer limits the maximum strength of the joint between Ti-6Al-4V alloy and 17-4PH stainless steel. There is a need for increasing the maximum strength of the joint between Ti-6Al-4V alloy and 17-4PH stainless steel by way of suppressing the reaction layer contained Ti—Fe intermetallic compound.

To this end, the barrier layer in accordance with the present invention is disposed on the connecting surface 17-4PH stainless steel so as to avoid the titanium atoms reacting with 17-4PH stainless steel. This result in suppression of forming a continuous reaction layer contained Ti—Fe intermetallic compound. Preferably, the barrier layer is selected from chromium-based, nickel-based or vanadium-based alloy. The barrier layer is formed on the connecting surface by a method selected from electroplating, electroless plating, physical vapor deposition (PVD), chemical vapor deposition (CVD) immersing and coating. The connecting surface of 17-4PH stainless steel is formed with chromium having a thickness of 10 or 40 μm by electroless plating. In an alternative embodiment, the connecting surface of 17-4PH stainless steel is formed with chromium having a thickness of 0.5 μm by PVD, and the chromium layer is further formed with nickel having a thickness of 0.5 μm by electroplating. Preferably, the barrier layer has a thickness ranging between 0.1 μm and 500 μm. Finally, the filler metal of 72Ag-28Cu is disposed between the connecting surfaces of Ti-6Al-4V alloy and 17-4PH stainless steel, and heated in an infrared-heating apparatus.

Table 2 shows experimental data of the combination of Ti-6Al-4V alloy/72Ag-28Cu alloy/17-4PH stainless steel forming a barrier layer (i.e. a control group) obtained in a shear test. In comparison with the experiment group shown in Table 1, the strength of the joint forming the barrier layer on 17-4PH stainless steel is specifically greater than that forming no barrier layer. The strength of the joint between the Ti-6Al-4V alloy and 17-4PH stainless steel is demonstrated from a comparison of the control group with the experimental group to be capable of being inferred as an increase of the strength of the joint at certain conditions. It is predicted that the barrier layer disposed between the connecting surfaces of the heterogeneous metal parts can improve the strength the brazed joint of the golf club head.

TABLE 2
Experimental Data of Ti—6Al—4V Alloy/72Ag—28Cu Alloy/17-
4PH Stainless Steel Forming a Barrier Layer

| Barrier | | Shearing stress | Avg. shearing |
|---|---|---|---|
| Layer (Thickness) | Temp. × Time | (MPa) | stress (MPa) |
| Cr (40 μm) | 850° C. × 180 sec | 69.2 | 68.2 |
| | | 67.2 | |
| Cr (40 μm) | 850° C. × 300 sec | 137.2 | 115.2 |
| | | 93.2 | |
| Cr (40 μm) | 900° C. × 180 sec | 121.1 | 98.0 |
| | | 74.9 | |
| Cr (40 μm) | 900° C. × 300 sec | 143.5 | 143.5 |
| Cr (10 μm) | 800° C. × 300 sec | 92.0 | 94.1 |
| | | 96.6 | |
| | | 93.6 | |
| Cr (10 μm) | 850° C. × 300 sec | 104.5 | 95.4 |
| | | 86.2 | |
| Cr (10 μm) | 900° C. × 300 sec | 74.8 | 64.6 |
| | | 54.4 | |
| Ni (0.5 μm) + | 900° C. × 180 sec | 88.0 | 88.0 |
| Cr (0.5 μm) | | | |
| Ni (0.5 μm) + | 900° C. × 360 sec | 87.0 | 87.0 |
| Cr (0.5 μm) | | | |
| Ni (0.5 μm) + | 950° C. × 180 sec | 117.3 | 117.3 |
| Cr (0.5 μm) | | | |
| Ni (0.5 μm) + | 950° C. × 360 sec | 113.5 | 113.5 |
| Cr (0.5 μm) | | | |

Although the invention has been described in detail with reference to its presently preferred embodiment, it will be understood by one of ordinary skill in the art that various modifications can be made without departing from the spirit and the scope of the invention, as set forth in the appended claims.

1. A joining method for connecting heterogeneous metal parts of a golf club head comprising the steps of:
prefabricating a first connecting surface on a first metal part, and a second connecting surface on a second metal part;
disposing at least one barrier layer on one of the first and second connecting surfaces of the first and second metal parts;
disposing a filler metal between said at least one barrier layer and one of the first and second connecting surfaces of the first and second metal parts such that the filler metal being sandwiched in-between the first and second metal parts;
heating the filler metal disposed between said at least one barrier layer disposed on said one of the first and second connecting surfaces and the other of the first and second connecting surfaces of the first and second metal parts; and
cooling and solidifying of the molten filler metal connected between the first and second connecting surfaces of the first and second metal parts to constitute the golf club head.

2. The joining method for connecting heterogeneous metal parts of the golf club head as defined in claim 1, wherein the heterogeneous metal parts are selected from a striking plate, a weight member, a golf club head body, a hosel and a crown plate.

3. The joining method for connecting heterogeneous metal parts of the golf club head as defined in claim 1, wherein the heterogeneous metal parts are constructed from metals selected from one of titanium-based alloy, ferrous-based alloy, nickel-based alloy and copper-based alloy.

4. The joining method for connecting heterogeneous metal parts of the golf club head as defined in claim 1, wherein the barrier layer is constructed from one of chromium-based alloy, nickel-based alloy or vanadium-based alloy.

5. The joining method for connecting heterogeneous metal parts of the golf club head as defined in claim 1, wherein the barrier layer is formed on the connecting surface by a method selected from electroplating, electroless plating, physical vapor deposition (PVD), chemical vapor deposition (CVD) immersing and coating.

6. The joining method for connecting heterogeneous metal parts of the golf club head as defined in claim 1, wherein the barrier layer has a thickness ranging from 0.1 μm and 500 μm.

7. The joining method for connecting heterogeneous metal parts of the golf club head as defined in claim 1, wherein the filler metal is constructed from one of silver-based alloy, copper-based alloy, titanium-based alloy and nickel-based alloy.
